(19) United States
(12) Patent Application Publication
(10) Pub. No.: US 2025/0111442 A1
(43) Pub. Date: Apr. 3, 2025

(54) Autonomous System for Real-time Legal and Tax Knowledge Updating

(71) Applicant: Reinhard Berger, Dubai (AE)

(72) Inventor: Reinhard Berger, Dubai (AE)

(21) Appl. No.: 18/479,073

(22) Filed: Oct. 1, 2023

(51) Int. Cl. G06Q 40/10; G06F 16/951; G06N 5/022

(52) U.S. Cl. CPC G06Q 40/10; G06F 16/951; G06N 5/022

(57) ABSTRACT

A system and method are disclosed for the autonomous, real-time updating of artificial intelligence (AI) models providing expert legal and tax advisory services. The system comprises a focused web scraper, heuristic filters, and optical character recognition to continuously gather regulatory updates without human effort. A neural relevance classifier trained via supervised learning scores the significance of scraped content. Approved updates are ingested by a natural language processor and validated before assimilation into the AI models. The system features comprehensive validation mechanisms, an immutable audit trail and versioning system, and a modular, cloud-native infrastructure for large-scale deployment. By combining these capabilities, the system is able to autonomously and continuously update the AI models' knowledge bases as regulations evolve over time. This maintains up-to-date specialty expertise in the models, ensuring users receive timely, accurate advice compliant with the latest laws, regulations, and precedents.

### FIELD OF INVENTION

The present invention generally relates to artificial intelligence systems, particularly knowledge representation, machine learning, and natural language processing techniques for creating self-adaptive expert systems. Specifically, the invention pertains to autonomous updating of AI models that provide specialized legal and tax advisory services to end users. The focus is on enabling AI systems to continuously maintain up-to-date domain expertise without human intervention.

### BACKGROUND OF THE INVENTION

The advent of artificial intelligence (AI) and machine learning has ushered in a new era of automated legal and tax advisory services powered by intelligent algorithms and predictive models. However, a persistent challenge faced by these AI systems is the necessity to maintain their knowledge bases in a current state, given the inherently dynamic nature of the legal and regulatory landscapes they operate within. Laws, regulations, case law precedents, and compliance standards are in a constant state of evolution at a rapid pace. To furnish precise and dependable advisory outputs, these AI models must possess up-to-date domain expertise that accurately reflects these continuous changes.

Nonetheless, a substantial portion of existing systems heavily relies on the manual identification, curation, and integration of new data to keep the AI models updated. Teams of human experts, including lawyers and tax professionals, are burdened with the ongoing responsibility of researching and analyzing emerging laws, bills, court rulings, and regulatory guidance to pinpoint pertinent alterations. Subsequently, this relevant information must undergo a manual process of interpretation and formatting for seamless integration into the AI models. This overall process is characterized by its extreme slowness, labor intensiveness, and susceptibility to human errors. Consequently, the AI systems' updates often lag behind by weeks or even months from the actual change events, seriously compromising their reliability and accuracy.

Some prior innovations have attempted to incorporate limited automated self-updating capabilities into advisory AI models. For instance, Sanchez proposed utilizing web scraping to automatically source new documents but lacked a validation system. Lee et al. employed a basic machine learning classifier but exclusively focused on news articles instead of official sources, which posed accuracy concerns. Furthermore, these techniques still required a substantial degree of human oversight for tasks such as identifying relevant documents, evaluating the significance of changes, and integrating them into models.

In reviewing several related patents and inventions in the field, it becomes evident that the present invention offers a unique and specialized solution in the domain of legal and tax advisory services. It is characterized by its comprehensive and autonomous self-updating mechanisms, which set it apart from other innovations.

CA3088243A1 specializes in the secure exchange and generation of legal documents, which is an essential aspect of legal services. However, it lacks the autonomous self-updating mechanisms specialized in legal and tax advice inherent to the RL application.

US20130290329A1 discloses innovations in legal relationship management and user-centric methodologies, which are significant in the legal domain. Nevertheless, it does not introduce specialized components for autonomous updating in legal and tax advice. It lacks the continuous learning and updating mechanisms from legal and tax-specific sources presented.

US20220366127A1 and US20200242306A1 primarily focus on automated legal document creation and user-centric methodologies, which are valuable contributions. However, they do not encompass or suggest the incorporation of autonomous self-updating mechanisms specialized in legal and tax advice inherent to the RL application.

KR20190015797A and U.S. Pat. No. 11,687,805 introduce methodologies for optimized answers and self-learning AI in the context of IoT. These are innovative in their own right but do not specialize or integrate autonomous updating mechanisms in legal and tax advice, a distinctive feature of the RL application.

U.S. Pat. No. 11,663,516 and CN109313586B present advancements in updating AI models and iterative training using cloud-based metrics, which are critical for AI development. However, they lack the specialized focus and integration of autonomous updating mechanisms in legal and tax advice found in the RL application.

U.S. Pat. No. 11,507,829 offers methodologies for developing AI models using parallel configurations and greedy approaches. While these are valuable techniques, it does not disclose the incorporation of autonomous self-updating mechanisms specialized in legal and tax advice inherent to the RL application.

CN108924910B focuses on AI model updating, an essential aspect of AI development. However, it does not integrate specialized autonomous self-updating mechanisms focusing on legal and tax advice, a salient feature of the RL application.

EP3836620A1 discloses an AI method specifically designed for legal services. This aligns closely with the legal and tax advisory domain. Nevertheless, it does not disclose or suggest the integration of autonomous self-updating mechanisms specialized in legal and tax advice, which is inherent to the RL application.

The present invention seeks to transcend these limitations by introducing a fully automated, end-to-end system designed for self-updating AI models in the realms of legal and tax advisory. This invention combines intelligent web scraping, neural classification, natural language processing, comprehensive validation, and transparent audit trails to enable the continuous updating of knowledge bases without any manual human intervention. The system is meticulously crafted to operate autonomously, emulating expert-level comprehension in the identification, analysis, and assimilation of regulatory changes into the AI models. This approach aspires to establish a new benchmark for maintaining legal and tax advisory AI models in an up-to-date, efficient, transparent, and scalable manner.

### SUMMARY OF THE INVENTION

The following summary is an explanation of some of the general inventive steps for the system, method, devices and apparatus in the description. This summary is not an extensive overview of the invention and does not intend to limit its scope beyond what is described and claimed as a summary.

Embodiments of the present disclosure may include a pioneering, end-to-end automated system for the continuous self-updating of artificial intelligence (AI) models specializing in legal and tax advisory services. This remarkable innovation eliminates the need for human intervention in the updating process, offering a new standard in the realm of automated legal and tax guidance.

According to one aspect, it is described a system comprising several key components, each contributing to its unparalleled functionality. The web scraper, an integral part of the system, combines a focused crawler with optical character recognition (OCR) and heuristics. This robust combination enables the scraper to target and extract regulatory updates from authoritative online sources. The system is highly customizable, allowing users to adapt it to different document types and websites, ensuring the precision and relevance of the data collected. In a non-limiting embodiment, the relevance classifier, a neural network trained via supervised or unsupervised learning, takes the extracted data and evaluates its significance. It employs advanced techniques such as entity matching and document classifiers to rank updates based on their importance. This process ensures that the system can differentiate between substantive changes and minor alterations, contributing to its accuracy and efficiency.

According to one aspect, the integration engine, a pivotal component of the system, processes the approved updates by ingesting them into the AI models. It goes a step further by converting the updates into a machine-readable format, allowing for seamless integration. The integration engine can handle both minor and major updates, ensuring that the AI models always operate with the most up-to-date information.

In another aspect, a robust validation subsystem plays a critical role in ensuring the quality and integrity of updates. This subsystem conducts a series of tests, including unit testing, integration testing, and user acceptance testing, both before and after integration. This meticulous validation process guarantees the system's reliability and the quality of the AI model's knowledge base.

In yet another aspect, immutable audit trail, which includes a comprehensive version history, provides transparency into the changes made to the AI models over time. This feature not only enhances accountability but also allows for easy tracking and, if necessary, reverting of model changes.

In a non-limiting embodiment, the system is architected on a microservices-based cloud infrastructure, incorporating containerization, orchestration, and auto-scaling. This enables large-scale deployment, ensuring that the system can handle substantial volumes of updates and accommodate a growing user base seamlessly.

The invention is distinguished by is its ability to autonomously and continuously update AI model knowledge bases. This is accomplished by combining the capabilities of the web scraper, relevance classifier, integration engine, validation subsystem, and audit trail, all within a scalable cloud infrastructure. This system eliminates the need for labor-intensive manual updates by human experts, addressing a fundamental challenge in the field of legal and tax advisory services.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 shows a system components according to one aspect including a web scrapper, data sources, evaluator, integrator and trained models, a user and their computer

FIG. 2 depicts the working mechanism of the evaluator according to one aspect.

FIG. 3 depicts the integration of new data to trained models by the integrator by passing the trained model and new data through the neural network to derive an updated model

FIG. 4 depicts the iteration of a trained model based on new data discoveries according to one aspect.

FIG. 5 depicts a cloud-based system architecture according to one aspect.

### DETAILED DESCRIPTION OF THE PREFERRED EMBODIMENTS

Hereinafter, the preferred embodiment of the present invention will be described in detail and reference made to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

The present invention discloses a novel, autonomous updating of AI models that provide specialized legal and tax advisory services to end users.

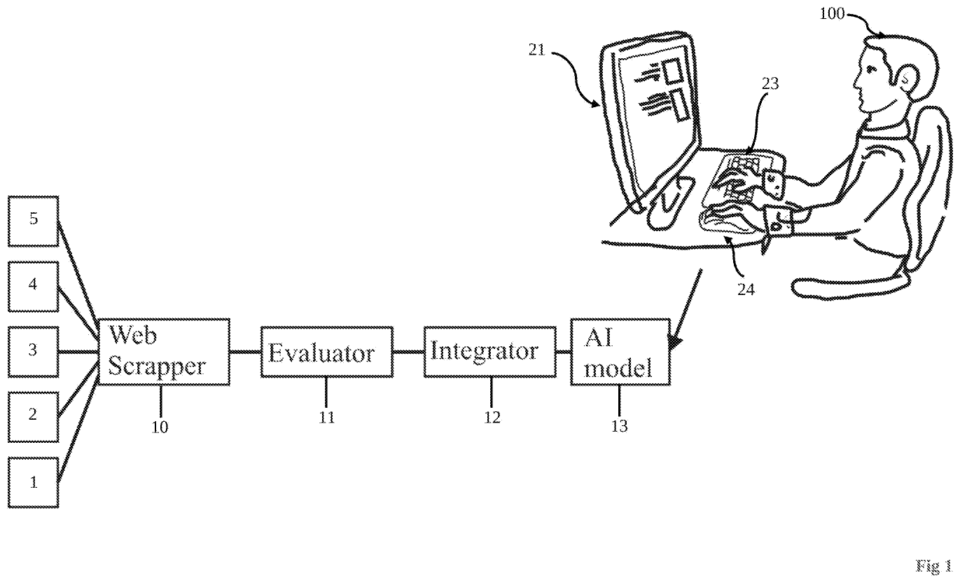

In a first embodiment, as depicted in FIG. 1, the system encompasses a set of core components designed to autonomously update AI models in the legal and tax advisory domain. These components include the web scraper (10), a collection of data sources (1, 2, 3, 4 and 5), an evaluator (11), an integration engine (12), and trained model(s) (13). The embodiment also introduces a user (100) interacting with their computer (21), equipped with a keyboard (23) and a mouse (24). Notably, the data sources (1, 2, 3, 4 and 5) represent a diverse array of potential origins for regulatory updates. These sources could encompass government websites, legislative databases, case law repositories, tax code databases, and financial news sources, among others. The variety of data sources underscores the system's versatility, as it can target and extract updates from a wide range of authoritative online locations, ensuring comprehensive coverage of the legal and tax domain. Moreover, the user (100) and their computer (21) are integral to the system's user interface. In this embodiment, the presence of a user and their computer, equipped with a keyboard and mouse, highlights the user interface aspect.

In one aspect, the web scraper is the system's data acquisition powerhouse, functioning as a focused crawler tailored to specific websites and publications known to host legal and tax-related updates. This meticulous targeting eliminates the need for manual filtering, ensuring that the collected data is inherently relevant. Leveraging optical character recognition (OCR), the web scraper can transmute various file formats into structured content, a vital capability for processing diverse regulatory updates accurately. Complementing its precision, heuristic algorithms sharpen the web scraper's ability to navigate a dynamic online landscape, consistently extracting pertinent data. This amalgamation of advanced features underscores the web scraper's proficiency in sourcing precise and real-time information, a foundational pillar of the system's functionality.

The evaluator (11) is a neural classification model trained through supervised learning, wielding its judgment to differentiate between substantive regulatory updates and inconsequential modifications. It operates as an invaluable filter, sieving out irrelevant or noisy data to ensure that only the most pertinent information is incorporated into the AI models. This meticulous relevance assessment process is pivotal, as it fortifies the AI models' precision, endowing them with the capability to provide dependable legal and tax guidance. The evaluator's role is indispensable in preserving the quality of the AI models' knowledge base, a cardinal objective of the invention.

The integration engine (12) represents the system's efficiency in processing and merging approved updates into the AI models. It translates relevant updates into a consumable format, facilitating seamless integration. Moreover, the integration engine's versatility is evident in its ability to batch minor updates and promptly incorporate substantive changes. This feature expedites the updating process, eliminating potential delays associated with manual integration. As a result, the integration engine plays a pivotal role in realizing the invention's fundamental objective of continuous and autonomous self-updating. It empowers the AI models to operate with real-time domain expertise, ensuring that users receive up-to-the-minute legal and tax advisory services.

According to one aspect, the trained model(s) (13) stand as the central pillar within the system's architecture, representing the culmination of the continuous self-updating process designed to empower legal and tax advisory AI models. These models are the product of intricate machine learning techniques, continually honed and enriched with an ever-expanding wealth of data. Their sophisticated learning mechanisms equip them to navigate the dynamic legal and tax landscape, seamlessly integrating newfound knowledge and adapting to evolving regulations.

These models are not static; instead, they embody a state of constant evolution and improvement. They absorb and internalize the knowledge curated by the web scraper and meticulously evaluated by the evaluator, thus ensuring that they remain in sync with the latest legal and tax developments. This dynamic self-improvement mechanism is pivotal, guaranteeing that the AI models are perpetually up-to-date, capable of delivering guidance that adheres to the most current laws, regulations, and precedents.

A defining feature of the trained model(s) is their precision in assessing relevance. Through rigorous training in relevance assessment, they have acquired a remarkable ability to distinguish between substantial regulatory changes and minor alterations. This precision is of paramount importance in the provision of accurate, dependable, and contextually relevant guidance to users. By including only the most pertinent data, these models uphold the high quality and credibility of the AI models' knowledge base.

In some non-limiting aspects, the user interface allows users to customize the system by specifying target data sources and determining the update frequency. In this manner, users can tailor the system to their specific needs, ensuring that it adapts to their requirements effectively.

In a non-limiting embodiment, the user (100) benefit from the system when seeking tax or legal guidance without the need for customization. The system's autonomous updates ensure that users consistently receive the most current and accurate information, enhancing the reliability of their advisory experience.

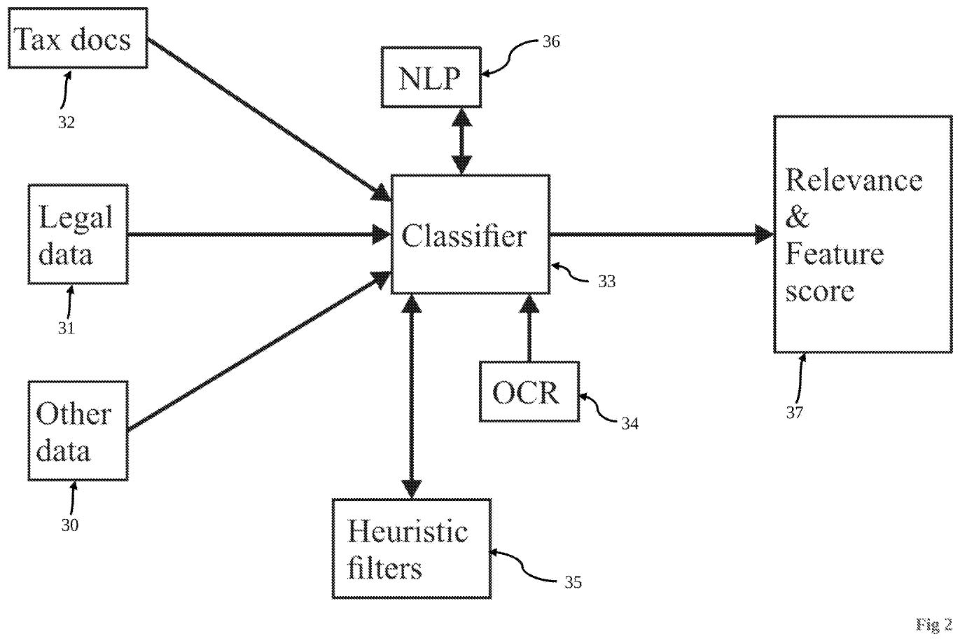

Now referring to FIG. 2 it is depicted the inner workings of the evaluator component, a pivotal element of the system responsible for assessing the relevance of the scraped data. In this embodiment, the evaluator is meticulously crafted to excel in filtering noise and evaluating the significance of the collected data types, ensuring that only the most pertinent updates are integrated into the AI models.

The figure shows some non-limiting and diverse data types represented as 31, 31, and 32. These data types encapsulate a wide range of regulatory information, including legal documents, tax reports, government publications, and more. The diversity of data types reflects the system's capacity to cast a wide net, covering multiple sources and document formats that might contain vital legal and tax-related updates. This breadth of coverage is crucial in maintaining the system's accuracy and comprehensiveness.

As an example, the classifier, at the core of this embodiment, plays a central role in the relevance assessment process. Trained through supervised learning, the classifier is an intricate neural network model designed to navigate the intricacies of regulatory data. It evaluates the scraped content and assigns relevance scores, a fundamental step in the system's ability to filter out noise and retain only the most significant updates. This evaluation ensures that the AI models are consistently fed with high-quality, substantive data, promoting their accuracy and reliability.

Further, the classifier's capabilities are significantly enhanced through the integration of specialized units, each serving a distinct function. The NLP unit (36) empowers the classifier to parse and comprehend the textual content of the scraped data. Natural language processing techniques allow the system to extract meaningful information, thus contributing to the classifier's ability to evaluate relevance accurately.

The OCR unit (34) is a critical feature for handling documents in various formats. It leverages optical character recognition technology, enabling the system to convert non-machine-readable data into structured content. This transformative capability ensures that the system can accurately process a myriad of document types, from scanned PDFs to image files, expanding its capacity to recognize and incorporate regulatory updates effectively.

To further illustrate, the heuristic filters (35) serve as an additional layer of refinement in the evaluator's functionality. These filters apply heuristics, refining the evaluator's ability to identify and extract updates from the ever-evolving online landscape. The heuristics improve the evaluator's accuracy in recognizing and capturing relevant information from a dynamic and sometimes chaotic web environment.

As such, FIG. 2 symbolizes the system's meticulous approach to evaluating the relevance of data collected from diverse sources and document types. Through the synergy of neural classification, NLP, OCR, and heuristics, this embodiment guarantees that the AI models are continuously updated with the most significant, high-quality legal and tax-related information, aligning with the system's core objective of delivering precise and reliable guidance to users.

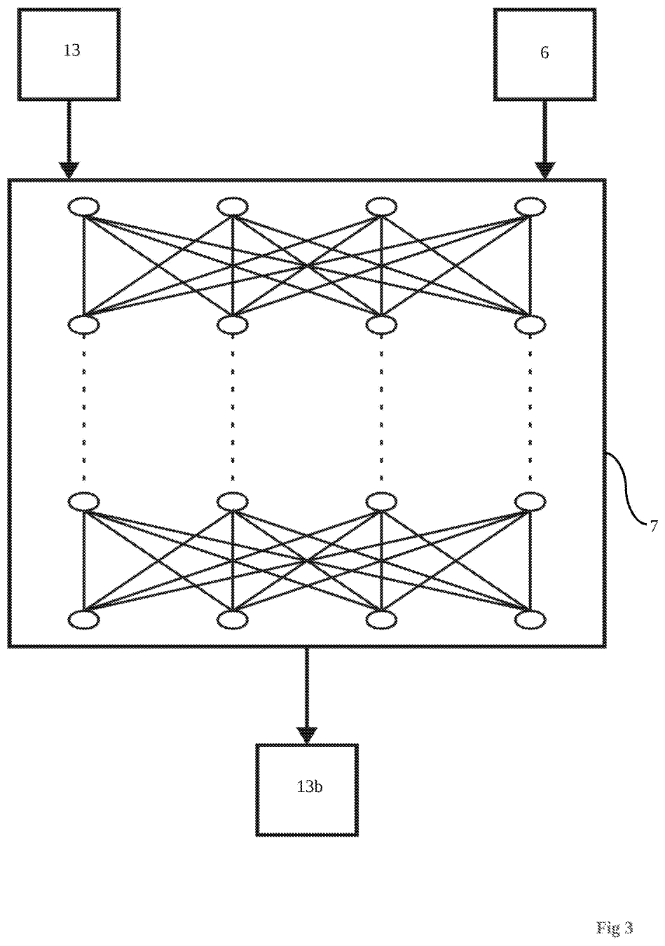

Now referring to FIG. 3 it is provided a depiction of the system's inner workings, specifically highlighting the integration Engine's role in incorporating new data into the trained models. This embodiment represents a vital process in the system's core objective: the continuous and autonomous updating of AI models to deliver real-time legal and tax advisory services.

As illustrated, this embodiment revolves around two exemplary components: the trained model (13) and newly discovered data (6). The trained model embodies a wealth of legal and tax knowledge, the culmination of the system's learning process, while the newly discovered data comprises a dynamic array of regulatory updates, legal documents, tax guidelines, and other relevant information gathered by the web scraper.

The neural network (7) an important role as the Integration Engine, serving as the pivotal intermediary. Whether hosted on a local computer or a remote server, the neural network plays a vital role in the integration process. It processes both the trained model and the newly acquired data, ultimately resulting in the derivation of an updated model. This neural network is finely tuned to navigate the intricacies of legal and tax content, ensuring a seamless and efficient integration process.

Incorporating natural language processing (NLP), the embodiment employs this crucial component to transform pertinent updates into a machine-readable, tokenized format. This step is vital in preparing the data for integration into the AI models, making it accessible and actionable for these models.

Furthermore, the embodiment may include the ability to manage the influx of updates efficiently. It can queue and process minor updates in batches, addressing mission-critical updates instantly. This batching feature optimizes the integration process, significantly reducing the risk of delays or bottlenecks that could otherwise hamper the system's real-time performance.

In one example, the Integration Engine directly interfaces with the AI model's knowledge graph for a successful integration process. Leveraging the model's native interfaces and protocols, it ensures that the updated information is seamlessly integrated into the AI models. This direct interaction guarantees that the models consistently operate with the most current domain expertise in the legal and tax fields, perfectly aligning with the system's fundamental objective.

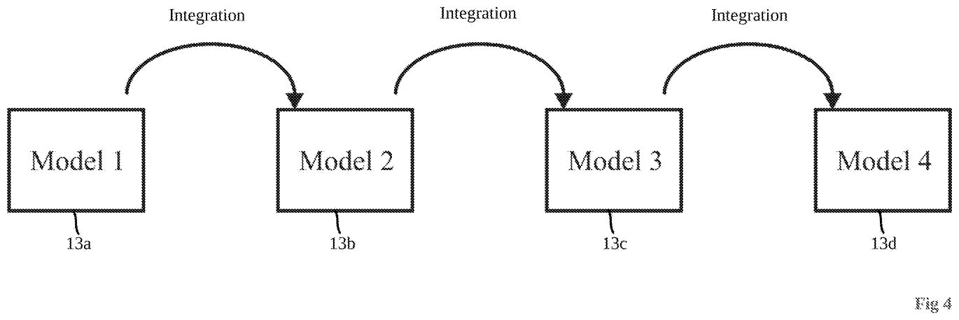

Reference is now made to FIG. 4, which portrays an embodiment that illuminates the iterative process of the trained model based on new data discoveries, a crucial element in the system's ability to ensure that its AI models remain at the forefront of legal and tax knowledge. This mechanism signifies the system's commitment to continuous improvement and the seamless adaptation of its AI models to the ever-evolving legal and tax landscape.

In this embodiment, the journey commences with Model 1 (13a). This model represents the system's initial iteration, incorporating a wealth of legal and tax knowledge. It serves as the starting point for the ongoing process of improvement and adaptation.

The iterative process begins with the integration of new data discoveries into Model 1 (13a). As the system continuously acquires fresh regulatory updates, legal documents, tax guidelines, and relevant information, these are thoughtfully incorporated into the existing model. This integration process results in the emergence of Model 2 (13b), which embodies an enhanced and updated understanding of the legal and tax advisory domain.

The evolution continues as Model 2 (13b) becomes the foundation for further improvements. New data discoveries are seamlessly integrated into this model, further enhancing its knowledge and accuracy. This process culminates in the development of Model 3 (13c), which now represents an even more refined and comprehensive understanding of legal and tax matters.

The embodiment underscores the system's unwavering commitment to providing users with the most accurate and up-to-date legal and tax advisory services. The iterative approach ensures that the AI models consistently evolve and adapt to the changing regulatory landscape, reinforcing their reliability and relevancy.

The last exemplary stage of this iteration process yields Model 4 (13d), the most advanced version in this particular embodiment. This model represents the embodiment's pinnacle achievement, embodying the most current, precise, and comprehensive legal and tax knowledge. It underscores the system's pursuit of excellence and its dedication to delivering top-tier advisory services to its users. As such, FIG. 4 encapsulates the embodiment's iterative process, emphasizing the system's commitment to continuous improvement. Through the integration of new data discoveries into evolving AI models, the system ensures that its legal and tax advisory services remain at the forefront of accuracy, reliability, and relevance, aligning perfectly with its core objective.

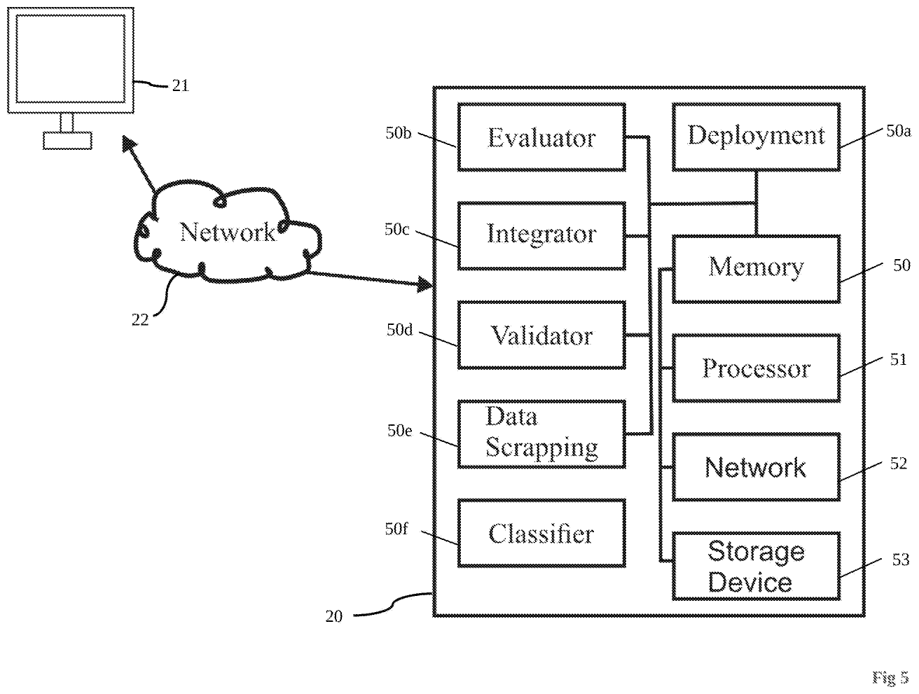

The non-limiting embodiment according to FIG. 5 provides a comprehensive illustration of the cloud-based system architecture, a critical aspect of the invention. This architectural embodiment demonstrates how the system leverages remote server resources to efficiently execute its autonomous updating processes and deliver seamless legal and tax advisory services to users.

In this depiction, we can observe a computer (21), which can represent a range of devices such as smartphones, personal computers, or any other device with internet connectivity. This computer, operated by the end user, serves as the point of interaction with the system. It connects to a remote server (20) via a network, which could be established through various means such as fiber optics, 5G wireless networks, broadband, or local area networks (LANs). This network connection is pivotal as it enables the exchange of data and instructions between the user's device and the remote server.

The remote server (20) stands at the core of the cloud-based system architecture and is equipped with several essential components. These components include a memory (50), processor (51), network (52), and storage device (53). The memory (50) hosts a set of coded instructions that constitute the system's fundamental modules. These modules are integral to the system's functionality and include:

Deployment module (50a): This module is responsible for initiating and managing the deployment of the system's components and functionalities on the remote server. It ensures that the system operates effectively within the cloud-based environment.

Evaluator module (50b): The evaluator module plays a critical role in assessing the relevance of scraped content and filtering out noise. It utilizes the neural classification model, trained via supervised learning, to ensure that only significant updates are integrated into the AI models.

Integrator (50c): This module is tasked with the seamless integration of approved updates into the AI models. It ensures that the knowledge base of the AI models remains current and precise.

Validation module (50d): The validation module is responsible for conducting a series of tests to ensure the integrity and quality of updates. It performs pre and post-integration testing to guarantee that the AI models operate with accuracy.

Data scraping module (50e): This module represents the web scraper's functionality. It is responsible for identifying and collecting regulatory updates from authoritative online sources.

Classifier (50f): The classifier module contains the neural network relevance classifier, which evaluates the significance of scraped content and assigns relevance scores to updates.

In a non-limiting embodiment, the validation subsystem and the audit trail, constitute pivotal features of the system, enhancing its robustness and transparency. The validation subsystem acts as a gatekeeper for incoming updates, employing a series of meticulous testing methods, including unit testing, integration testing, and user acceptance testing. These assessments serve to validate the quality and appropriateness of the updates before and after integration into the AI models. By systematically scrutinizing the updates, the system ensures that the integrity and reliability of the AI models' knowledge base are consistently maintained. On the other hand, the audit trail functions as a historical recorder of model changes, encapsulating details such as the content added, relevance scores, and timestamps for each update. This traceability and transparency provide an indispensable tool for tracking the evolution of the AI models over time. It allows for the retrieval of historical data, enabling users to review, verify, and understand the changes made to the AI models, thereby contributing to accountability, regulatory compliance, and the quality of the legal and tax advisory services provided by the system.

The present invention can be implemented in various configurations, depending on the requirements of the specific use case and the technical considerations. It may manifest as a standalone device or a distributed client-server architecture. In the standalone approach, all processing and analysis occur locally on a single device without the need for external communication. Alternatively, the client-server model divides the tasks between a client device responsible for collecting and transmitting data and a server tasked with performing intensive analysis before returning results to the client. The client-server model allows for the utilization of more robust computing resources on the server side. The choice between these implementations depends on factors such as real-time processing requirements, batch processing needs, data volume, and security considerations, all of which play a role in determining the most suitable approach.

It is envisaged that the present invention may be embodied as a system, method, or computer program product at varying levels of technical integration. A computer program product embodiment may consist of computer-readable storage media containing instructions for a processor to execute the innovative steps disclosed herein.

Furthermore, the invention may be embodied as computer-readable program instructions, enabling a general-purpose computer to execute the novel functions via a connected processor. These instructions, residing on storage media, effectively guide the computer, processor, or other programmable device to operate as described in the flowchart, block diagram, and accompanying descriptions. Therefore, the storage media encapsulates an article of manufacture that contains the computer-readable program instructions for implementing the innovative aspects.

While a preferred embodiment has been described for illustrative purposes, it is acknowledged that experts in the field may recognize the possibility of variations, additions, and substitutions without deviating from the scope and spirit of the invention, as defined by the accompanying claims. These foreseeable modifications are anticipated and intended to be included.

Consequently, the applicant aims to encompass such modifications, combinations, and integrations that fall within the scope and purpose of the disclosed invention. The use of singular terms is intended to encompass plurals, unless otherwise stated or evident within the context. Conjunctions, such as “and/or,” should be interpreted broadly to mean “and,” “or,” or “and/or,” unless constrained by the context.

### INDUSTRIAL APPLICATION

The present invention for knowledge representation, machine learning, and natural language processing techniques for creating self-adaptive expert systems s profoundly impactful in the fields of legal and tax advisory services. By providing an autonomous system for continuous updating of AI models, it enhances the accuracy, reliability, and timeliness of guidance to individuals and businesses navigating complex legal and tax landscapes. This technology empowers professionals in the legal and financial sectors by ensuring that AI models always operate with up-to-date knowledge, making it a valuable tool for law firms, tax consultancies, and financial institutions. It sets a new industry standard for efficient, transparent, and scalable automated legal and tax advisory, significantly improving the quality of service provided.

What is claimed is:

1. A system for autonomous updating of artificial intelligence (AI) models for legal and tax advisory services comprising:
a. a web scraper to identify regulatory updates from predefined sources;
b. a classifier trained via supervised learning to evaluate relevance of updates;
c. an integration engine to ingest approved updates into AI models;
d. a validation subsystem to ensure integrity of updates; and
e. an audit trail to log model changes.

2. The system of claim 1, wherein the web scraper utilizes optical character recognition and heuristics.

3. The system of claim 1, wherein the integration engine tokenizes updates into a machine-readable format.

4. The system of claim 1, wherein updating of AI models is performed without human involvement.

5. The system of claim 1, wherein the audit trail maintains immutable provenance of model changes.

6. The system of claim 1, wherein a microservices-based architecture enables scalable deployment.

7. A computer-implemented method for autonomous updating of AI models providing legal/tax advisory, comprising:
a. scraping authoritative online sources to identify regulatory updates;
b. evaluating relevance of updates using a supervised trained classifier;
c. ingesting approved updates into AI models;
d. systematically validating updates both pre and post integration;
e. maintaining an audit trail of model changes.

8. The method of claim 7, wherein scraping uses optical character recognition and heuristics.

9.

10. The method of claim 7, wherein evaluating relevance involves feature extraction.

11. The method of claim 7, wherein ingesting updates involves tokenizing them into machine-readable format.

12. The method of claim 7, wherein the audit trail provides version history and provenance.

13. The method of claim 7, further comprising retraining the classifier on new labeled data.

14. The method of claim 7, implemented using a microservices-based architecture.

15. The method of claim 7, wherein updating is performed without human involvement.

16. A computer program product embodied on a non-transitory storage medium for performing the method of claim 1 when executed on a system.

17. The computer program product of claim 16, wherein the program is adapted to interface with legal and tax AI models via an application programming interfaces.

18. The computer program product of claim 16, further providing alerts when the AI model is updated.

19. The computer program product of claim 16, wherein the change logger maintains provenance metadata of model changes.

20. The computer program product of claim 16, wherein the validation module verifies regulatory compliance of updates.
